(19) United States
(12) Patent Application Publication
(10) Pub. No.: US 2009/0211899 A1
(43) Pub. Date: Aug. 27, 2009

(54) Production method of equipment which carries out decomposition and separation for a gas molecule

(76) Inventor: Yoshio Niioka, Sparks, NV (US)

Correspondence Address: Yoshio Niioka, 28 Chyohata Tomituka, Ichinomiya City, Aichi Ple, JP

(21) Appl. No.: 12/072,059

(22) Filed: Feb. 25, 2008

(51) Int. Cl. B01D 53/62

(52) U.S. Cl. 204/194

(57) ABSTRACT

This technology is a workshop which is diffusing the carbon dioxide gas (CO2) contained in exhaust gas in the air, It invents for the purpose of sanctifying microbes, such as sanctification of the emission gas (especially CO2 gas) of all industries, such as a diesel engine vehicle, a large-sized generating station (thermal power), a large-sized vessel, and an airplane, and also a toxic substance of atmospheric.

Of course, the unit which this laboratory invented carrying out a disassembly and a separation for the molecule of nanometer unit of measures, such as gas of carbon dioxide gas (CO2) and a microbe, contained in exhaust gas, and reducing discharge of carbon dioxide gas (CO2) annihilates the disease germ of atmospheric.

Carbon dioxide gas (CO2) of atmospheric is decreased by invention of this unit, and the global warming by greenhouse effect is solved.

### THE TECHNICAL FIELD BELONGING TO INVENTION

This invention relates to the production method of the equipment which carries out decomposition and separation of the gas which can carry out decomposition and separation for bacteria and the carbon dioxide (CO2) gas molecule of a toxic substance more than a submicron or nanometer.

### THE CONVENTIONAL TECHNOLOGY

The application number of the patent to which applicant Yoshio Niioka submitted the conventional technology to the Japanese Patent Office has Heisei 11-51310 and 2003-418708.

### OBJECT OF THE INVENTION

Since mitigation of carbon dioxide (CO2) is needed for preventing global warming, it aims at offering the method of manufacturing at low cost so that this invention (production method of the equipment which carries out decomposition and separation for a gas molecule) may be introduced to the world and global warming can be prevented.

### THE MEANS FOR SOLVING A SUBJECT

The equipment which carries out decomposition and separation for the carbon dioxide (CO2) gas molecule called mechanism of a toxic substance, bacteria, and global warming was able to be invented, and it was able to distribute to carbon (C) and oxygen (02).

By installing this equipment in a factory, plant, the sealed habitation space, the large-sized small engine currently used for vehicles, and an airplane and other spacecrafts etc., an exhaust gas can be processed and cultivation of the plant with in a spacecraft is also possible.

Furthermore, in order to sanctify the microbe which is a toxic substance of atmospheric, it invents for the purpose of installing this unit in a hospital a henhouse, etc. where a microbe etc. breeds easily, and preserving an environment.

### THE EFFECT OF INVENTION

This invention can separate 20% or more for oxygen, in order for there to be an effect which carries out a disassembly and a separation about a carbon-dioxide (CO2) gas molecule and to carry out 90% or more of a separation and a disassembly for carbon (C) from a carbon-dioxide (CO2) molecule.

The molecule of a carbon dioxide (CO2) is combined at a rate of the oxygen molecule 2 and the carbon-content child 1 (2:1).

A liquid electrostatic induction generating pipe is installed in the equipment which carries out decomposition and separation of this molecule, a shaft axis is further installed in the inner diameter center of that pipe, and the rotating electrode wings which have spiral form are exactly installed in a shaft side. They are a pump and a blower exactly about the electrolysis water solution and carbon dioxide (CO2) gas which melted in water the chemicals indicated inside the pipe at claim 1 while rotating these electrode wings. It injects from discharge-jet 4b10a currently installed centering on the pipe of 29a shown in the section of the main part 1 of FIG. 5, an electrolysis water solution is mixed with carbon dioxide (CO2) gas in the core of pipe 29a29b29c, and it flows through the inside of pipe 29a29b29c.

The electrolysis solution which was injected by FIG. 5 which has installed electrolysis solution in the main-unit tank 1 explained in FIG. 1 at the pipe from the jet orifice 27 of the sectional view of the main-unit tank 1 of a description, and went into the main-unit tank 1 of FIG. 1 maintains amount of water, and is collected by the electrolysis solution storage tank 4a currently installed exactly.

As for an electrolysis water solution, Pump 8a is supplied to carbon dioxide (CO2) by the blower 11b.

As for rotation of Pump 8a and blower 11b11c, each is control led by the electric motor at 1900 rpm, and number of rotations is the method of controlling with the concentration of the gas.

In the case of the operation, since it was carrying out by 100% of carbon dioxide (CO2) concentration, the number of rotations of the electric motor 7a was set as 1500 rpm-2000 rpm.

Speed of such a stream composition to electrolysis solution, and gas The mechanism constituted from the liquid electrostatic-induction rotating-electrode wings and the liquid electrostatic-induction selection film filter 21a which have the spiral form which control led, made the exact fluence inside pipe 29a29b29c, and was installed in the pipe is built, and the synergistic effect is used, The way of carrying out a disassembly and separation of a carbon-dioxide (CO2) molecule by electrolysis solution was able to be discovered, and this unit was able to be invented.

The process which the decomposed oxygen and carbon separate is explained in FIG. 4b.

The liquid electrostatic induction selection film filter 21a installed in the core of a centrifugal-separator rotation drum The carbon grain child who carbon is adsorbed, and oxygen passes through the said liquid electrostatic induction selection film filter 21a, and are collected by the blower 11c of oxygen tank FIG. 1 explains the situation collected from the water tank 4a of FIG. 1 with the electrolysis water-solution pump 8a in FIG. 11.

above
(1) Electrolysis water solution (shown in claim 1)
(2) Liquid electrostatic induction rotating electrode wings 26a26b26c which has the spiral form shown in the perspective diagram of FIG. 6a
(3) Liquid electrostatic induction generating pipe 29a29b29c
(4) It consists of these parts of the liquid electrostatic induction selection film filter 21a.

By having invented the molecule decomposition equipment of this gas and having completed, global warming can be prevented and the high production method of mass production nature can be offered.

### BRIEF EXPLANATION OF THE DRAWINGS

FIG. 1 The arrangement plan table part of the whole production method of the main-unit tank 1 (unit which carries out a disassembly and separation of a gas molecule) is shown.

FIG. 2 The production method routing figure back part of the main-unit tank 1 (a disassembly and decollator of a gas molecule) is shown.

FIG. 3 The partial component-partses sectional view of a molecule disassembly of main-unit tank 1 gas and the production method of decollator, a perspective diagram, and the enlargement of a fracture part and one copy are shown.

FIG. 4a The exploded view of the centrifugal-separator casing-upper half 2a, the main part 18 of a centrifugal-separator rotation drum, and the centrifugal-separator casing lower half 2b is shown.

Partial sectional drawing of the main part tank 1 is shown.

FIG. 4b The sectional view of the casing 2a of the centrifugal-separator rotating-drum cross section 23a and a centrifugal-separator upper portion and the lower casing 2b is shown.

FIG. 5 The schematic inside main part tank 1 sectional drawing is shown.

FIG. 6a The perspective diagram of the parts constituted by main part tank 1 core is shown.

FIG. 6b The perspective diagram and side elevation of the main part tank 1 are shown.

FIG. 7 The figure of the replacement parts which solved the meal-proof wear and abrasion resistance of the shaft axis 31 by ceramic coating is shown.

FIG. 8 The exploded view of the parts supporting the whole shaft axis 31 rotation part is shown.

FIG. 9 Sectional drawing of the schematic of the sleeve 34 supporting the rotation part of the shaft axis 31 is shown.

FIG. 10 Sectional drawing of the specialized tool from which the parts constituted inside the sleeve 34 are desorbed is shown.

FIG. 11 Indicate sectional drawings in part to be sectional drawing of the production method of the liquid electrostatic induction selection film filter 21a, a plan, and a perspective diagram.

FIG. 11A-1 The status that the fiber used as a string is rolled is shown.

FIG. 11B-2 The string of a fiber is shown.

FIG. 12 The front elevation of the equipment which carries out decomposition and separation of a gas molecule, a plan, and a side elevation are shown.

FIG. 13 Arrangement plan of unit which carries out disassembly and separation of gas molecule, piping diagram and gas, system configuration figure showing fluence of electrolysis solution

### EXPLANATION OF A MARK

1 Main part tank (the form (side elevation) of the figure which the main part tank completed is shown)
2a Main part centrifugal-separator casing-upper half
2b Main-unit centrifugal-separator casing lower half
2c The magnet for solenoid valves
3 The cylinder for carbon dioxides (CO2)
4a The storage tank of electrolysis solution
4b The spare tank of electrolysis solution
4c The injection nozzle of electrolysis solution
5 Oxygen collection tank
6a6b Exhaust gas pipe
7a centrifugal-separator rotation drum
7b pulley
7c belt
7d electric motor
8a The pump for electrolysis solution
8b The pipe for washing
8c A liquid electrostatic-induction selection film filter washing pump and a nozzle
9 The door for liquid electrostatic induction selection film filter exchange
10 The injection nozzle for carbon dioxides (CO2)
10b-1 The tubing for carbon dioxides (CO2)
10b10c Over-flow pipe (valve for pressure regulations)
11a The tubing for oxygen (02)
11b11c Blower
12 Main part attachment tank base
13a and 13b Main part covering
13c and 13d Drainage discharge jet
14 The arrow which shows an enlargement
15a and 15b Shield packing
16a and 16b Bearing
17a The shaft axis for rotation drums
17b Connection shaft
18a The main part of a centrifugal-separator rotation drum
18b Covering control of a filter
19 Rotation drum casing and covering of 6a and 6b
20 Covering of the exhaust gas pipes 6a and 6b
21a Liquid electrostatic induction selection film filter
21b A filter washing discharge jet and a pipe
21c Drainage electromagnetic valve
21d Drainage discharge jet
22 Gas extraction discharge jet
23a Centrifugal-separator rotation drum section
23b Drainage electromagnetic valve
24 Drainage discharge jet
25 Bolt hole
26a, 26b, and 26c Liquid electrostatic induction rotating electrode wings which have spiral form
27 Injection nozzle
28a and 28b Connection pipe which passes gas and an electrolysis water solution
28c The arrow which shows the flow of gas and an electrolysis water solution
28G Arrow which shows the flow of gas
28W Arrow which shows the flow of an electrolysis water solution
29a, 29b, and 29c Liquid electrostatic induction generating pipe
30 The replacement parts which solved wear of the shaft
31 Shaft axis
32 Cap
33a Blind flange
33b Packing
33Fa Flange
34 Sleeve main part
35a and 35b Bolt
36 Gland packing
37 Washer
38 Spring
39 The cap for sleeve main parts
40 Bearing attachment bracket
40a The outside diameter of a bearing receptacle and a bore is an exhaust gas pipe which carries out the role of the exhaust gas pipes 6a and 6b.
41P Main part of ceramic coating attachment parts
42V It is V type about the tip of attachment parts. Attachment part of a tool which processes a slot
42P Sectional drawing of the replacement parts which performed ceramic coating
42Z The tool only for desorption of parts
42Y The handle of a specialized tool
42U The arrow which shows the direction which draws out parts
43 Key seat
44 Synthetic fiber
45a Synthetic resin silicon
45b Synthetic resin silicon adhesives
46 Pile cut textiles
47 The production method surrounded from the pipe others perimeter
48 The pipe which processed the bore hole into size
49 The arrow which shows the outlet of gas
50 The string of a fiber
51 The state which opened the string of the fiber
52 The state where the fiber used as a string is rolled
53 The film of the shape of jelly raised by the chemical reaction of alkali and the acid
54 A black point is a point that a substance adsorbs.
55 A field without a gas leak

### CASE OF THE OPERATION

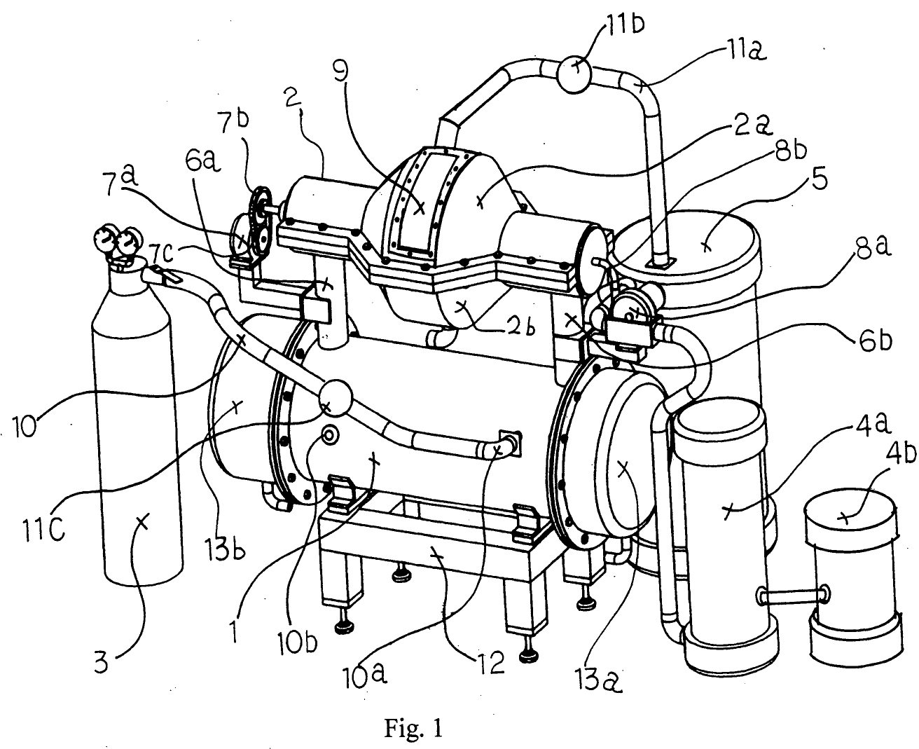

Next, when the production method of the equipment which carries out decomposition and separation of a name gas molecule from schematic FIG. 1 of the case of the operation of the present invention is explained, about the material of the equipment which carries out decomposition and separation for a gas molecule, and parts, they are 1600 mm in length of a main part tank, and 600 mm in diameter. The 300 mm[in width]×bore of 600 mm is [each of main part covering 13a13b of this tank] a product made from a plastic in two pieces.

The quality of the material is using three SUS-304 at 1500 mm in length of a shaft axis, and 25 mm in diameter.

As for the liquid electrostatic induction generating pipe, the quality of the material is using three SUS-304 at the outside diameter of 145 mm, and 3 mm in thickness.

As for the outside diameter of spiral form rotating electrode wings, the quality of the material attaches 15 pieces at 150 mm using SUS-304, as for 100 mm and length, and the mounting arrangement of these rotating electrode wings is an argon gas-welding processing method.

As for the diameter of the electrolysis water-solution storage tank 4a and the electrolysis water-solution spare tank 4b, the quality of the material is manufactured by the plastic by 900 mm in height at 600 mm.

The outside diameter of the oxygen collection tank 5 uses 1200 mm, as for length, the quality of the material uses iron at 1300 mm, and the core of a tank is coated with the epoxy resin.

As for the length of piping, the number of the magnitude of a hose band is 180 pieces in about 60 m using 35 mm 25 mm and 15 mm.

The length of casing of the upper part of main part centrifugal-separator 2a2b and the lower part is a maximum of 600 mm in outside diameter in 1400 mm.

The diameter of a central drum is 500 mm in 1200 mm in length of the centrifugal-separator rotation drum 23a.

The quantity of the outside diameter of exhaust gas pipe 6a6b is two pieces in 400 mm in length at 120 mm.

In addition, the number of required parts is two about the motor for water pumps of two sets and output 1.5 kw in the motor of the main drive of the blower motor of output 1.7 kw of three sets and output 3.7 kw.

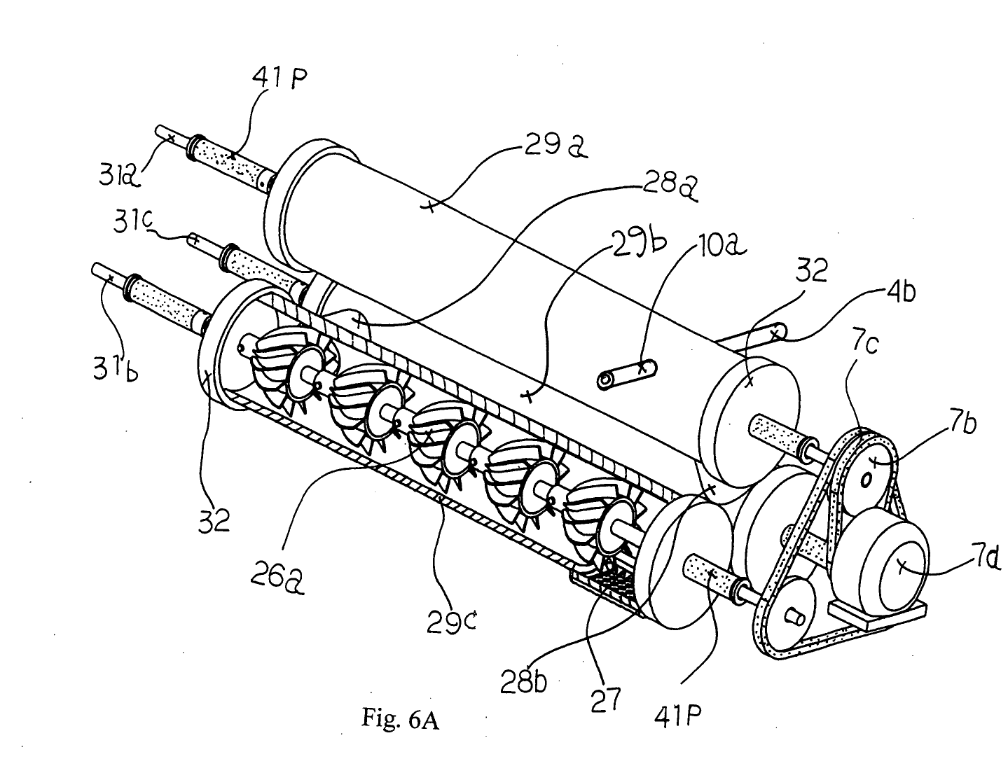

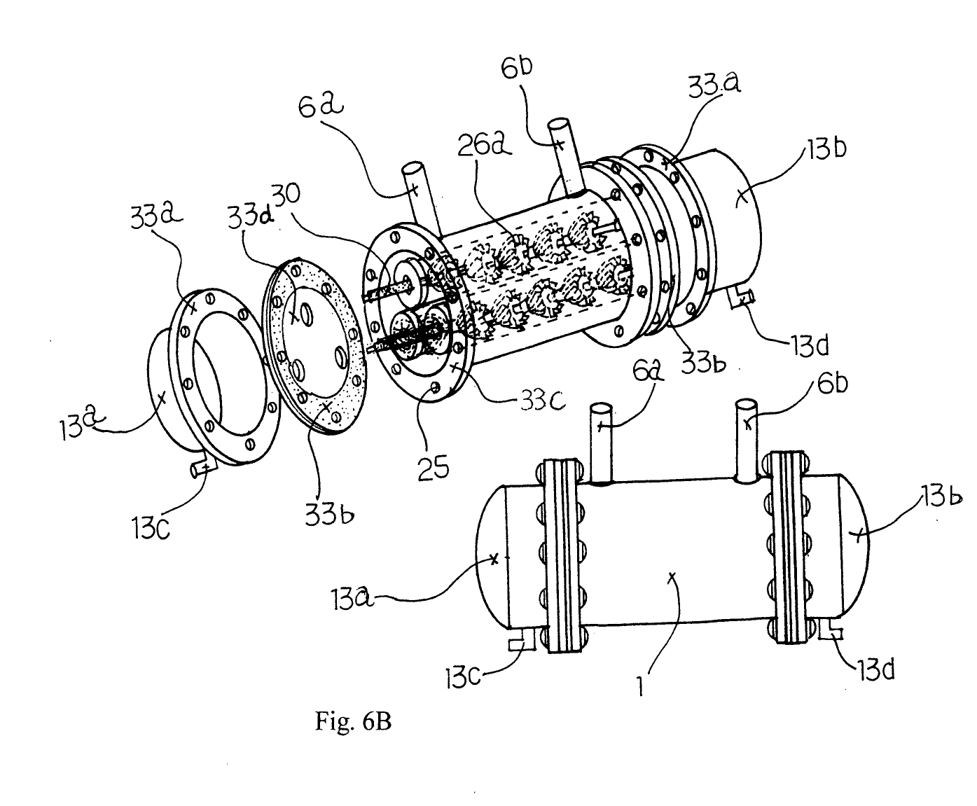

The liquid electrostatic induction generating pipes 29a and 29b which have explanation in the perspective diagram of FIG. 6 in a main part tank with the above parts are connected to 28a, 29c and 29b are connected to 28b, the mixed water of gas and an electrolysis water solution is poured, and it is exactly constituted by the connection pipe.

Liquid electrostatic-induction occurrence rotating-electrode wings 26a26b26c which has spiral form in shaft axis 31a31b31c shown in FIG. 6 centering on the connected pipe of 29a29b29c is exactly attached to a 15-piece shaft side.

The shaft axis 31A way to constitute centering on the pipe of 29a29b29c, process the hole diameter of 28 mm for shaft axis 31 into cap 32 centering on six caps, attach six quantities to three pipes 29a29b29c by right and left, and twist the leak from cap 32, and a gas leak for cap 32 It constitutes exactly.

If FIG. 6b explains, a 28 mm hole is processed on the plane of the blind flange 33a shown in a perspective diagram and a side elevation, and the blind flange 33a is constituted with the group in the main part tank 1.

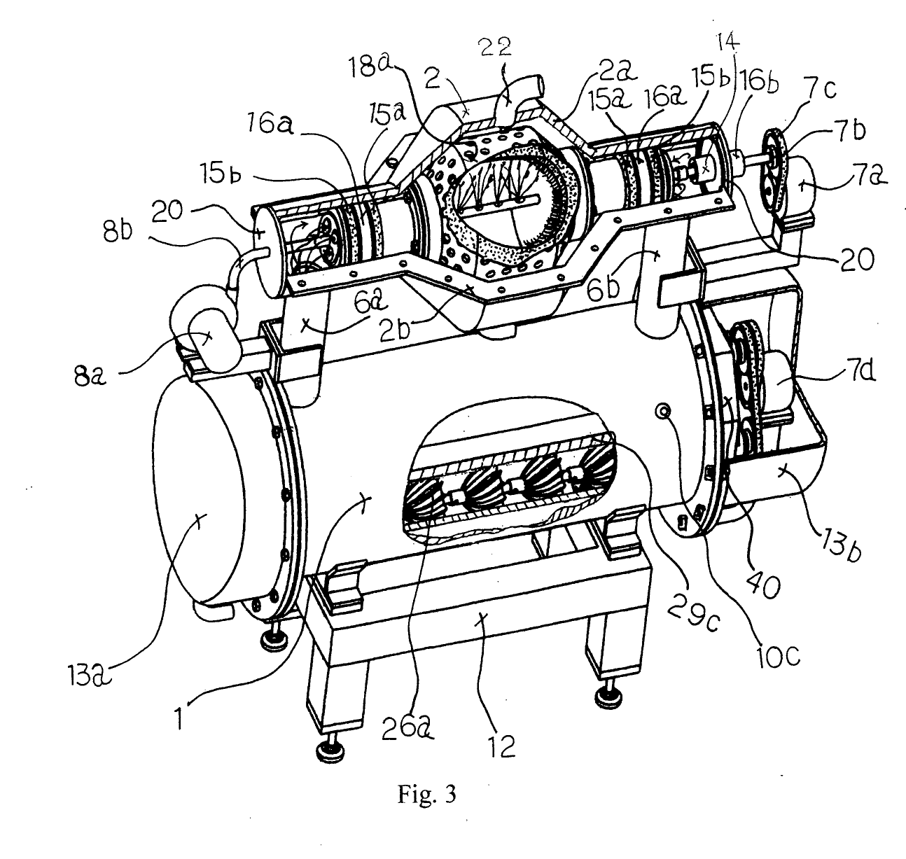

The fraction of the field which installs six bearings 16a in the blind flange 33a side exactly constituted in flange 33Fa and a bolt hole for the shaft axis 31 which constitutes six places exactly and rotates shaft hole right and left exactly at an overall and where a shaft rotation part hits is shown in 7b of FIG. 3.

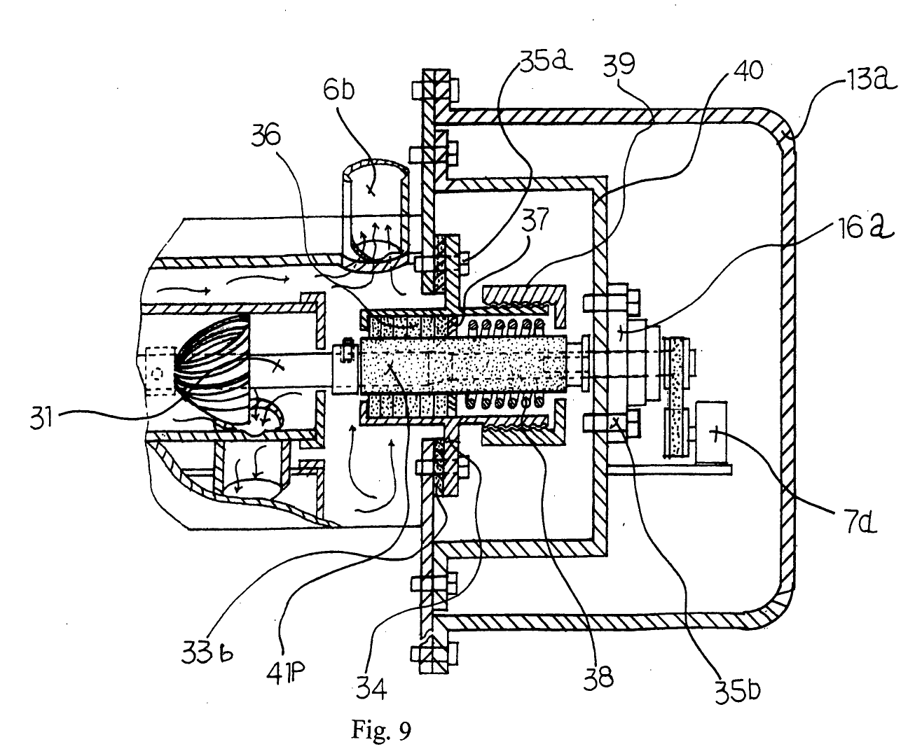

The place in which the electric motor was installed is shown in FIG. 9.

It has the stream composition that main-unit cover 13a13b is installed, and neither gas nor electrolysis solution leaks, and the form of the side elevation which the main-unit tank 1 completed is shown in FIG. 6b.

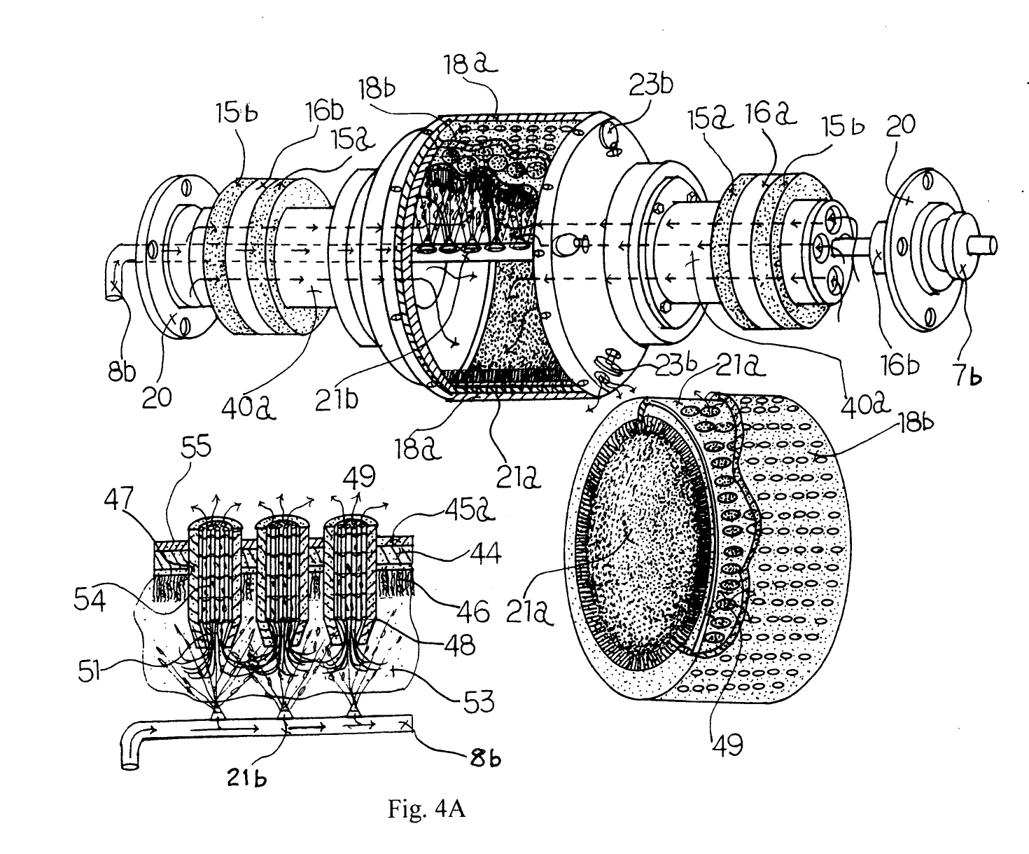

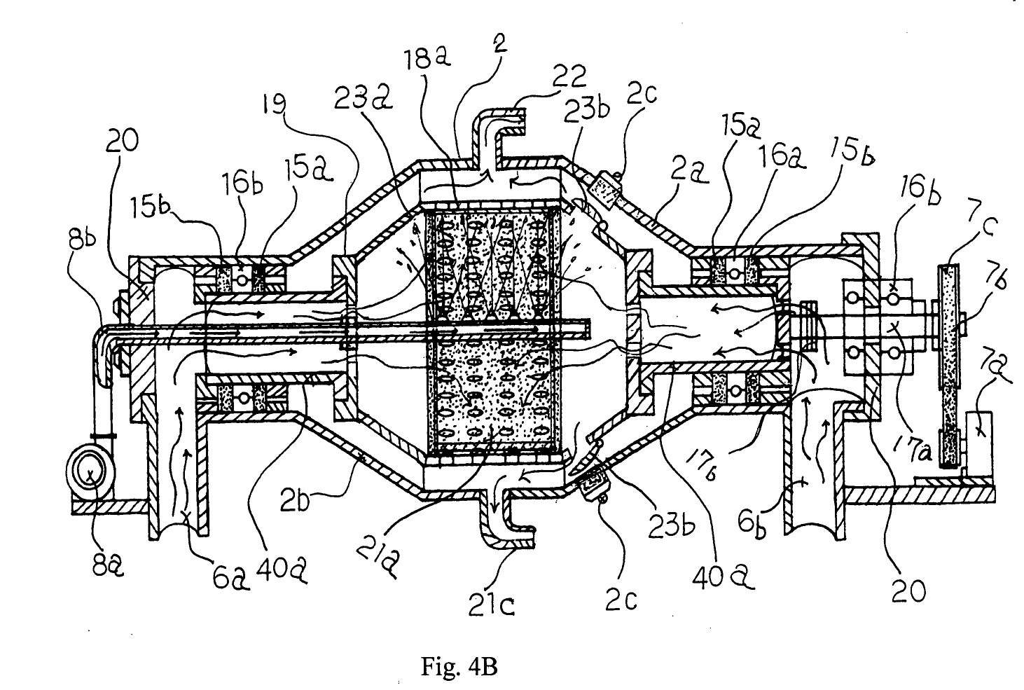

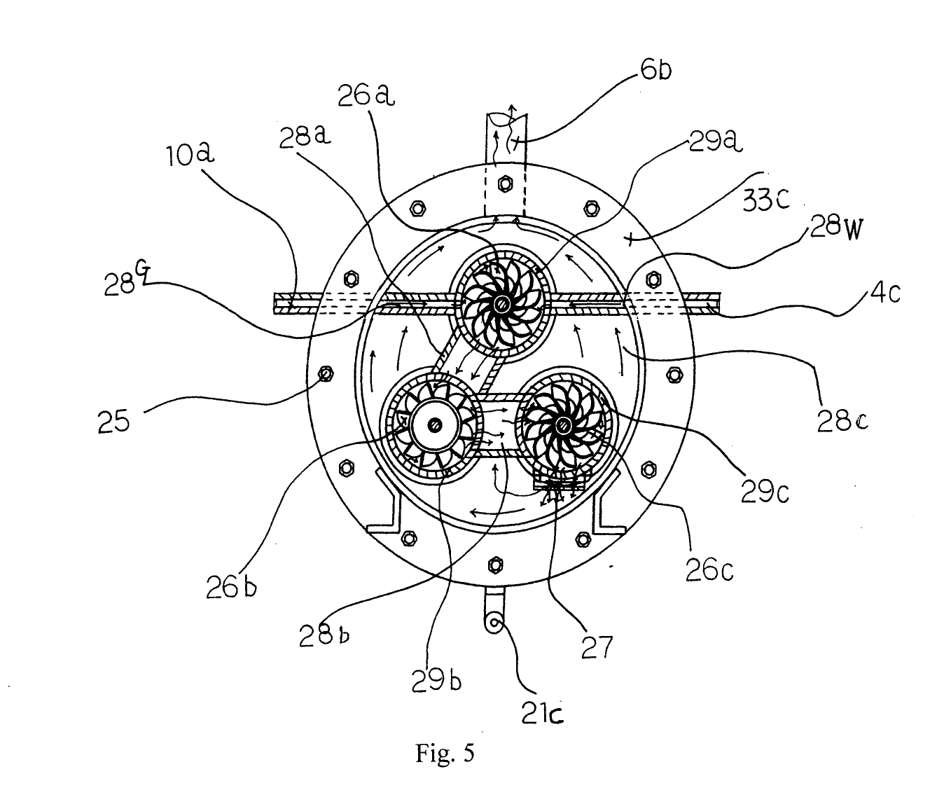

Exhaust gas pipe 6a6b is connected with the casing 2b of the centrifugal-separator lower part of FIG. 4b in the upper part.

Exhaust gas pipe 6a6b is horizontally installed in right and left of the centrifugal-separator rotation drum 23a shown in sectional drawing of FIG. 4b. A washing pipe is installed from a washing pump centering on the exhaust gas pipe of this 6a6b, and the liquid electrostatic induction selection film filter 21a is attached to the center of the centrifugal-separator rotation drum 23a. Since a filter side will become dirty with exhaust gas if work becomes prolonged operation, it is necessary to install a timer exactly, and it is necessary to control washing.

Thus, exhaust gas flows into centrifugal-separator rotation drum 23a right and left, and rotation is given to the rotation drum 23a in other one [the method of installing a pipe 6 and the bearings 16a and 16b which exhaust gas flows through the center of 6b, and serve as a central axis of the rotation drum 23a at an outside, and] direction.

Motors 7a, 7b, and 7c are production methods with which exhaust gas flows, giving exactly transfer of the rotation from the shaft axis 17 for centrifugal-separator rotation drums.

The centrifugal-separator rotation drum 23a is exactly installed in the center of the centrifugal-separator casing-upper half 2a of the main part tank 1, and the centrifugal-separator casing lower half 2b.

FIG. 4b of sectional drawing consists of such methods.

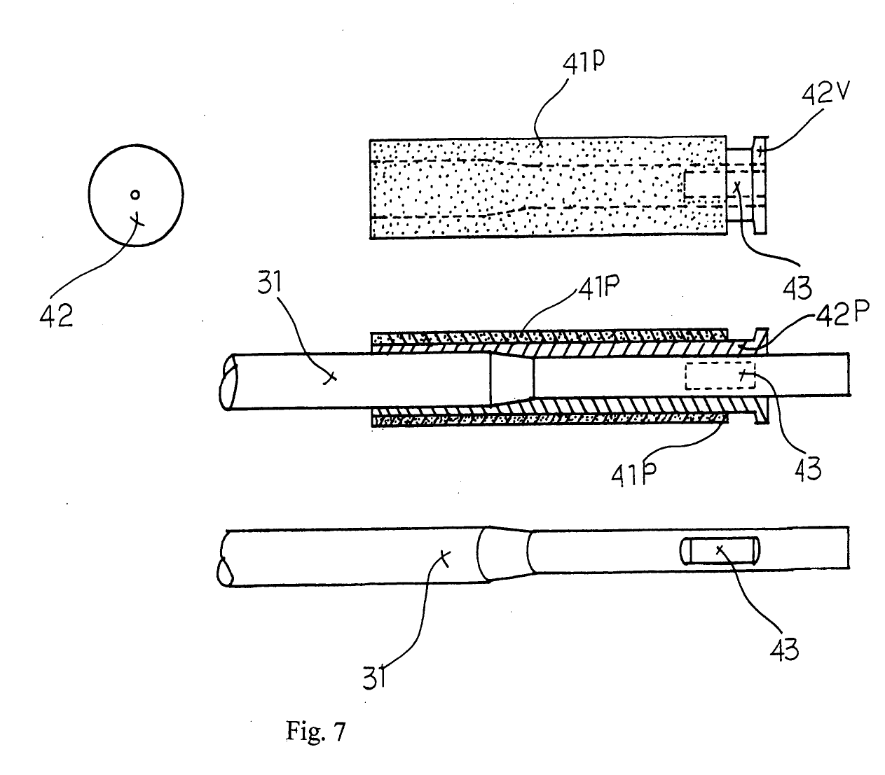

FIG. 7 shows the figure of the main part 42P of replacement parts which solved meal-proof wear and abrasion resistance by the ceramic coating which has the meal-proof antiwear quality of the shaft axis 31.

Six quantity of the whole shaft axis 31 is set to the core of the main part tank 1.

As shown in sectional drawing of FIG. 9, the shaft axis 31 consists of sleeve main parts 34, installs the shaft axis 31 focusing on a sleeve 34, installs gland packing 36 in the perimeter part of the shaft axis 31, and installs gland packing 36 in the perimeter part of the shaft axis 31, A washer 37, a spring 38, sleeve It consists of cap 39, a bearing attachment bracket 40, and a bearing 16.

A rotation of the shaft axis 31 is the electric motor 7. A rotation is exactly changeable.

Since it solved by carrying out ceramic coating of the anticorrosion wear resistance of the shaft axis 31 of FIG. 7, if the explanation is given, about the replacement component partses 42P (shown in a sectional view), Slot 42V will be made at a leading end at a perimeter part, It is the way of choosing exactly the field of the shaft 31 with anticorrosion wear and abrasion resistance, exchanging the outline of the shaft, carrying out a hole manipulation at the bore of the component partses 42P, and giving ceramic coating to the whole perimeter part required side of the replacement component parts 42P.

The ceramic material can choose thermal resistance and chemical resistance exactly with the liquid to be used.

In this case of the operation, the thickness of ceramic material processes 50 micro oxidization chromium with the plasma spraying equipment made from METC0. As for the quality of the material, replacement component partses are manufactured by SUS-304 by 5 mm of outer-diameters 150 mm in length using NC lathe. Although there is only the way of only drawing out the whole shaft from an equipment with the conventional technology, attachment and detachment of component partses take much time, and when it sees from the economical field where a cost is high, there is also a hangup.

The service life of the shaft which are the replacement component partses by this invention has a service life of 100 times or more rather than the technology of the conventional shaft.

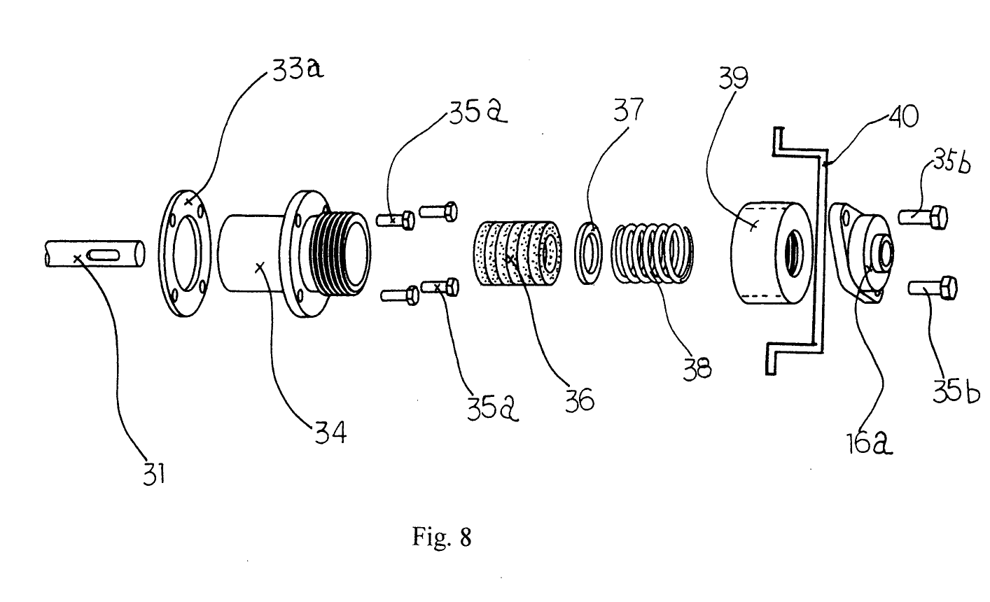

Furthermore, a desorption of component partses being little as explained to FIG. 7 FIG. 8 FIG. 9, and the system itself can make it work for a short time. Although ceramic coating is directly given to the shaft and the way was performed with the conventional technology still now, the testing result of the service life when using the conventional shaft directly in a molecule disassembly and decollator of gas was as short as about 50 hours.

Therefore, since a problem will occur in the whole unit if a shaft is worn out in 50 hours and a leak occurs, the conventional shaft cannot be used.

It exchanges, even if a leak occurs before a service life and the replacement component partses 41P by this invention become replacement time, and the main units 41P and 42P of component partses are manufactured beforehand.

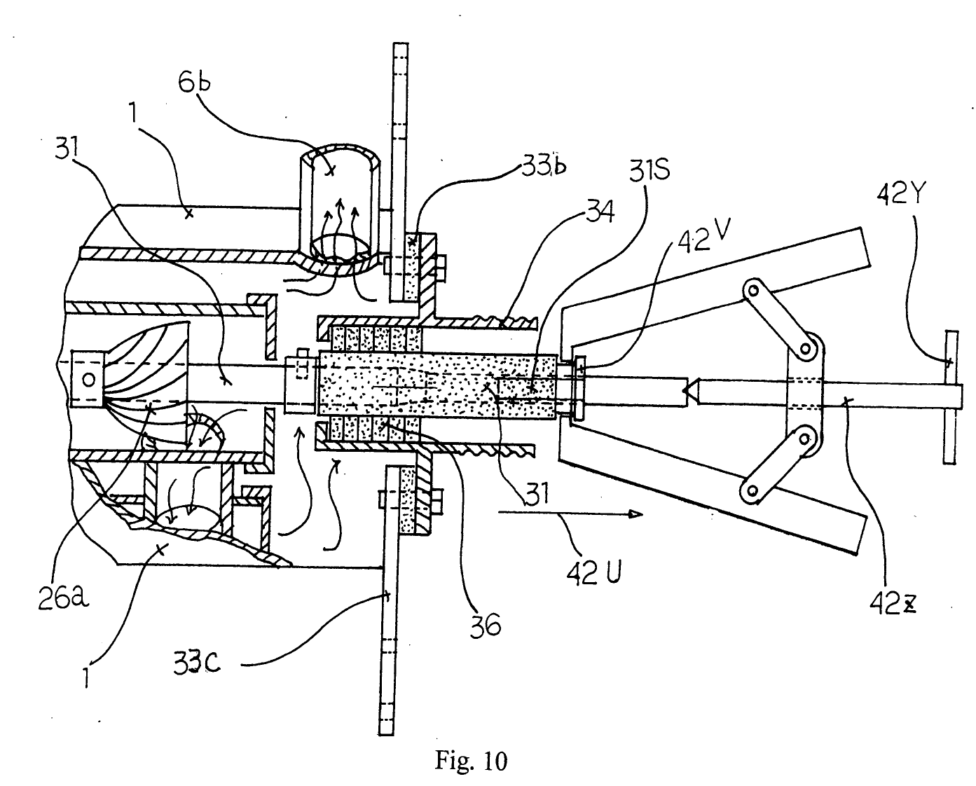

A desorption and the switching of the component partses constituted by the manipulation side 42V inside the sleeve main unit 34 of FIG. 10 at the time of element replacement can do the main unit 42P of replacement component partses simply by the tool only for a desorption.

Moreover, it replaces with the ability for the material of 42P to also be chosen freely and to be manufactured exactly, and recycling of component partses is also possible.

Although desorption exchange of some component partses shown in the replacement component partses of FIG. 8 by this invention can be performed for a short time, since it desorbed the whole shaft and has coated wear-proof with the conventional technology directly at that shaft, it requires a long time for manufacture and becomes a cost overrun.

Main-unit 41P42P of the replacement component partses of a production method which gave ceramic coating with high quality and robustness which gave ceramic coating by this invention is used only for the unit which carries out a disassembly and separation of FIG. 1 of the gas molecule of a main-unit tank fraction.

Therefore, replacement component-partses 41P42P which has hi-reliability by the present invention can be offered.

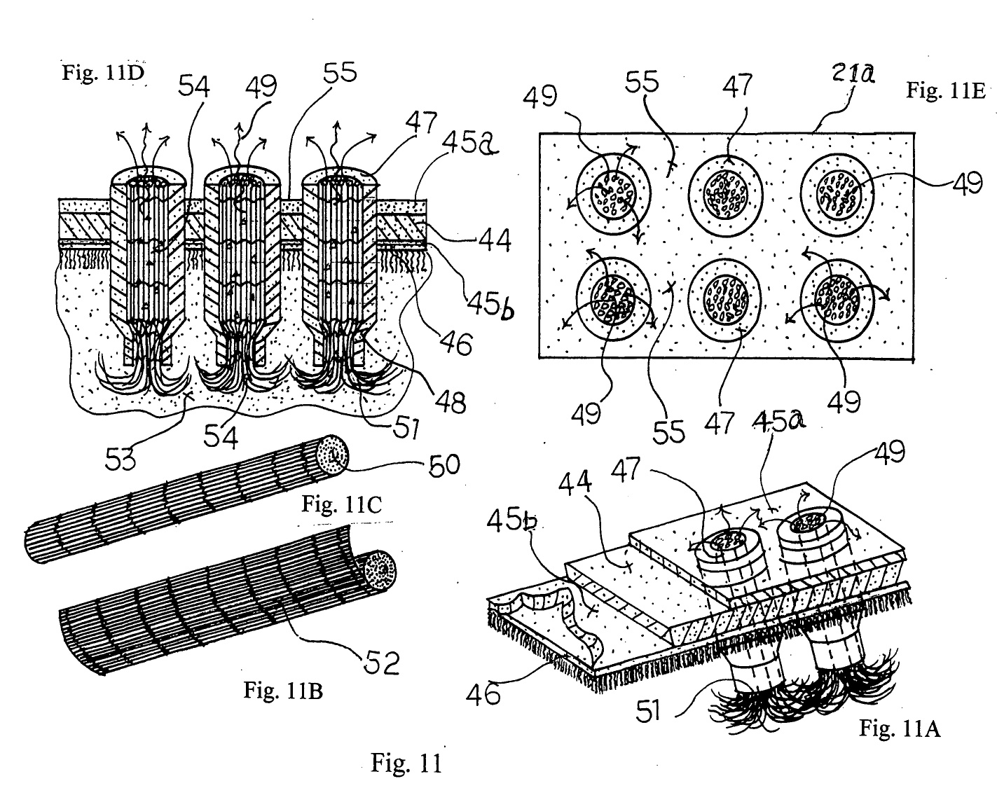

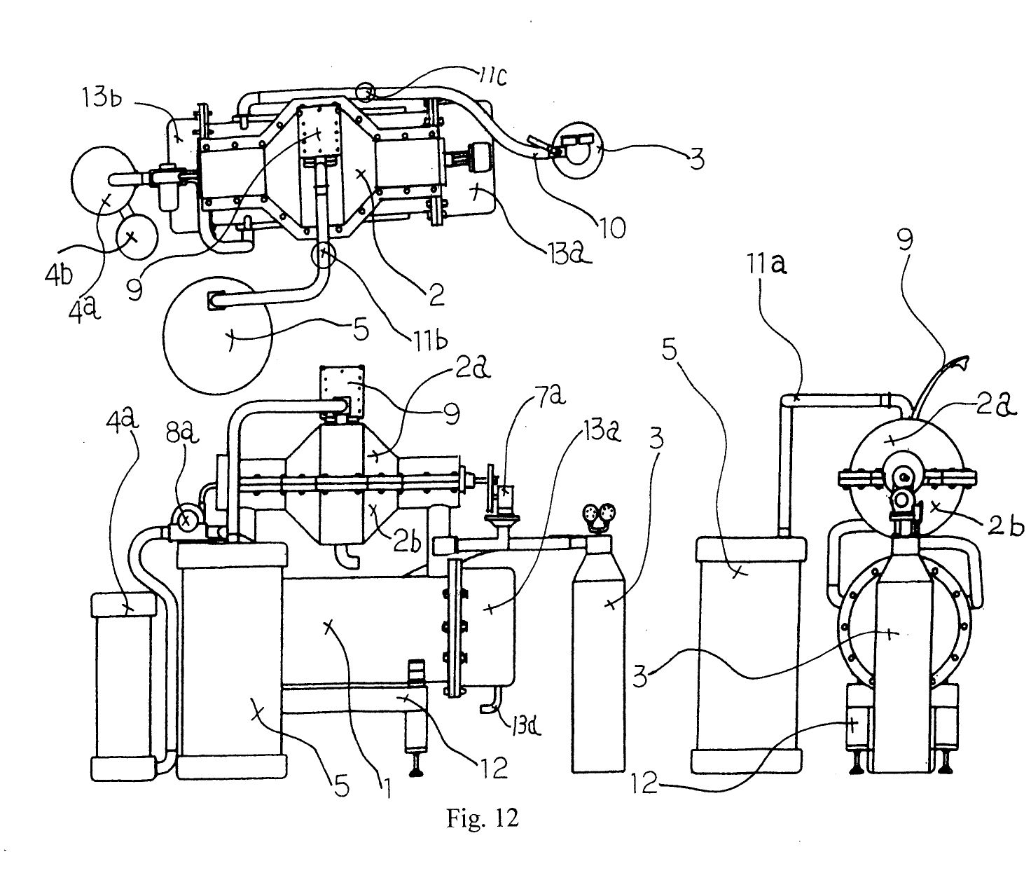

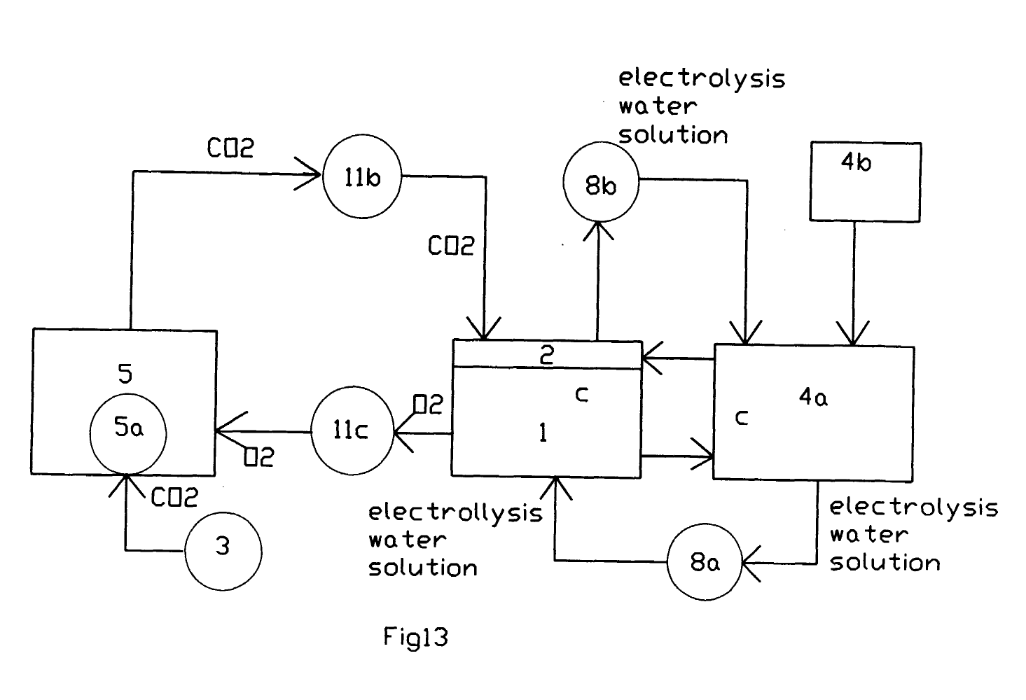

When the production method of the liquid electrostatic-induction selection film filter shown in FIG. 11 was explained, the synthetic fiber 44, the synthetic-resin silicon layer 45a, and the synthetic silicon adhesives 45b were used, and the fiber of a pile cut status was woven, and it stuck on the whole surface, and manufactured as sandwich construction.

The dimensions which the liquid electrostatic-induction selection film filter of the sandwich construction object needs are about 1,000 mm×800 mm, and thickness manufactures a 10 mm thing.

The pipe 47 made from plastics is processed into the sandwich construction object in 8 mm of bore holes of 10 mm of bore hole lower inside of 15 mm of 35 mm outer-diameters [in total length] top inside, and 1,280 pipe quantities manufacture.

A 14 mm hole was made in the rear view from the sandwich construction body surface, the pipe of 15 mm of outlines was attached compulsorily, and with the adhesives of synthetic-resin silicon, the perimeter of the pipe 47 was fixed so that there might be no gas leak.

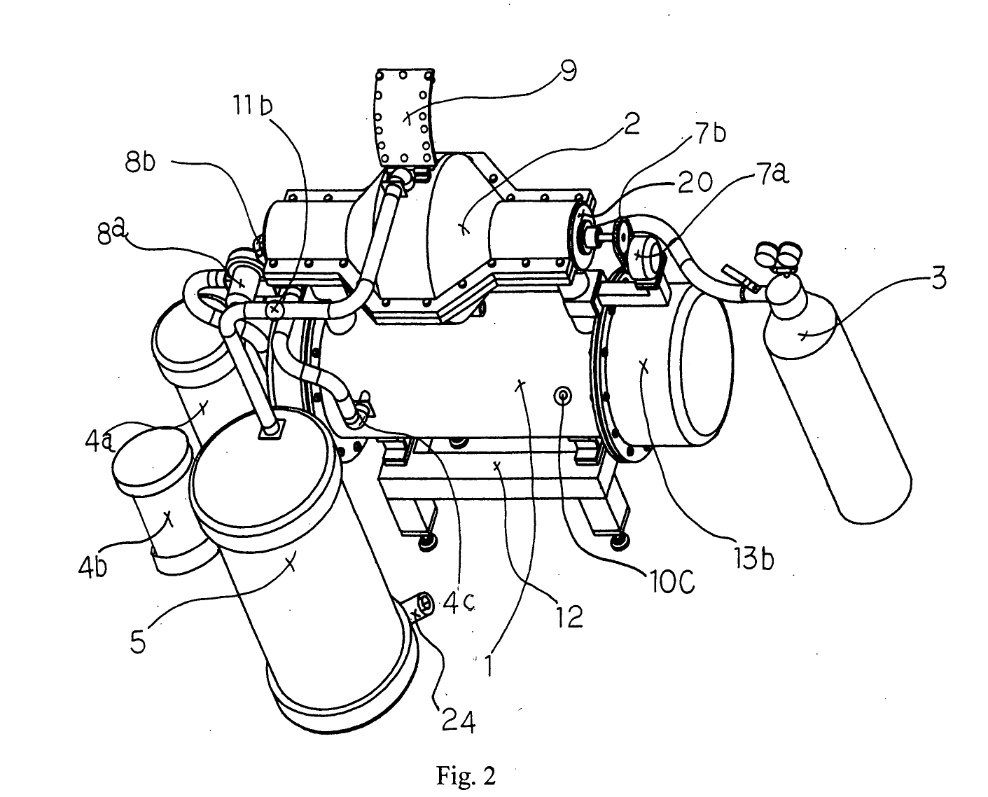

While the fiber shown in 51 is shown in 52 of FIG. 11A-1 of the fiber exactly knit by the way of turning towards the vertical upper and lower sides It is constituted by the way which processed form like one core 50 of a fiber of FIG. 11B-2, attached to the hole of the pipe 47 with a 15 mm of outer-diameters bore of 10 mm compulsorily, and compressed a little hole of 8 mm of lowers.

If the fiber 52 knit to the longitudinal direction explains it, one string 50 of a fiber will process exactly the purpose which serves as a base material of a liquid electrostatic-induction selection film filter, and attached the pipe 47 in order to make the string 50 not fall in the orientation of lower and to control the fluence of gas.

Thus, a hole manipulation of the bore of a pipe 47 is a production method constituted by the way of adjusting and choosing the hole diameter of a upper portion and a lower as a size.

It is the way of making a large and small hole in the bore of a pipe 47, constituting the bore fraction of a pipe 47 for the fiber 52 knit in the shape of a string in the hole in the orientation of vertical, and constituting a liquid electrostatic-induction selection film filter.

Since carbon-dioxide (CO2) gas is acidity and electrolysis solution is alkalinity, if alkaline water is arbitrarily mixed with carbon-dioxide (CO2) gas, the jelly-like film 53 will be raised.

Organization in which the retroaction whose molecule carries out a disassembly and a separation occurs If the sectional view of FIG. 11 explains, it will generate by giving electrostatic induction to the film of the shape of the jelly. If carbon-dioxide (CO2) gas and electrolysis solution are injected on the liquid electrostatic-induction rotating-electrode wings which have the spiral form of 26a, 26b, and 26c, a friction will occur around [to rotate] rotating-electrode wings, an impulse and an oscillation will be received, and electric field will be raised.

An anion and a positive ion are generated the bipolar molecule of the molecule of the water in the electrolytic solution being arranged, and forming an electric double layer.

It comes to invent the unit which discovers the organization in which use the ion, destroy the structure of an electric double layer, use the mechanism formed again, and carbon-dioxide (CO2) gas is separated, and carries out a disassembly and separation of a molecule.

A disassembly and decollator of the molecule of the present invention are driven, and it is a foundation. When the measurement was requested to TOKAI GIJUTU center and incorporated company YUNIKEMII, the effect as follows became clear. Measurement date April 6, Heisei 19

### Measurement Location

### 28, Nagahata, Tomitsuka, Ichinomiya-city, Aichi-ple

Incorporated company PSYTEX research laboratory

When the carbon dioxide (CO2) was put 100% into the unit which carries out a disassembly and separation of a molecule and was driven to it at the above-mentioned location, it is in a tank.

In a carbon dioxide, 2% or less remains. Oxygen is 20% or more.

It became a measurement result which carbon dioxide gas is changed and remains.

### (Refer to Reference Data 1)

measurement implementation person Foundation TOKAI GIJUTU CENTER

Measurement Equipment Best SOKUKI C0 and CO2 gas-analysis meter BCC-611 (non-distributed infrared type) Best SOKUKI Oxygen analysis meter BMG-100 type (magnetic type)

Furthermore, the place which extracted and measured the electrolysis solution currently used with this molecule disassembly and decollator Extraction day April 6, Heisei 19

Incorporated company Place which requested the verify of the amount of total carbon to YUNIKEMII Liquid A 4 mg/l Liquid

It became a measurement result more than B 3,600 mg/l.

### (Refer to Reference Data 2)

An inspection method is a total-organic-carbon-analyzer method.

Water B is electrolysis solution after making this unit drive in electrolysis solution before Water A drives the unit which carries out a molecule disassembly and a separation by the identifier which having used the above with the water A and B of the description attached temporarily.

It is proved that the retroaction of a disassembly and a separation is started from the above measurement result within the unit with which a carbon dioxide (CO2) carries out a molecule disassembly and a separation.

Moreover, about the further description of a measurement result, it is as the reference data 1 and 2.

1-17. (canceled)

18. An apparatus for decomposition of CO₂, comprising
a CO₂ conversion chamber that uses electrolyte solution to condition CO₂ producing a filmy, gelatinous substance which contains a mixture of carbon, oxygen, un-processed CO₂ and electrolyte solution;
a carbon-oxygen separation chamber that separates carbon from oxygen in the filmy, gelatinous substance.
